(19) United States
(12) Patent Application Publication
(10) Pub. No.: US 2009/0211132 A1
(43) Pub. Date: Aug. 27, 2009

(54) Signage System for a Cargo Vehicle

(76) Inventors: Stephen Rosa, Reno, NV (US); James Biersach, International Falls, MN (US)

Correspondence Address: EDELL, SHAPIRO & FINNAN, LLC, 1901 RESEARCH BOULEVARD, SUITE 400, ROCKVILLE, MD, 20850, US

(21) Appl. No.: 12/348,802

(22) Filed: Jan. 5, 2009

Related U.S. Application Data
(60) Provisional application No. 61/018,779, filed on Jan. 3, 2008.

(51) Int. Cl. G09F 13/22; G09F 15/00

(52) U.S. Cl. 40/544; 40/606.01

(57) ABSTRACT

A system for mounting signage onto the door area of a vehicle is disclosed. The system includes a mounting assembly and a display substrate. The mounting assembly includes a series of brackets operable to capture the display substrate against the panels of a roll-up door system. Specifically, the brackets may include an upper bracket mounted to the uppermost door panel, a lower bracket mounted to the lowermost door panel, and a plurality of side brackets each selectively mounted to one or more of the door panels. The substrate is configured to flex at predetermined points to accommodate the pivoting of adjacent door panels during the opening/closing of the door.

### CROSS REFERENCE TO RELATED APPLICATIONS

This application is a nonprovisional application of provisional application 61/018,779, filed 3 Jan. 2008 and entitled “Mounting Arrangement for Displays on Roll-up Doors,” the disclosure of which is incorporated herein by reference in its entirety.

### FIELD OF THE INVENTION

The present invention relates generally to a signage system for the rear face of a delivery or cargo vehicle having a roll-up door.

### BACKGROUND OF THE INVENTION

Outdoor advertising is growing in importance as commuters spend more time on highways. The rear of cargo trailers and delivery vehicles present a challenge for wide carriage graphics because the doors must remain free to open and close in the normal conduct of business. Many ideas have been proposed that envision stretching a flexible substrate over the horizontal roll-up door panels. These panels are typically 12 or 16 inches in vertical width, and these designs typically have the flexible substrate anchored along the top edge of one of the upper panels using a dowel or similar rod held in place along the top of the substrate with a hem of some kind. The lower edge of the flexible substrate is then held in place by some tensioning means, including elastic straps, springs or other options so that when the roll up door is closed the tensioning means pulls the substrate taught over the underlying horizontal panels. The tensioning means are supposed to offer sufficient ‘give’ so that as the door is rolled up, the tensioning means release the flexible substrate enough to accommodate the added effective door height created by the gaps between the horizontal panels as the door lifts up and bends to follow the tracks running up and into the roof of the cargo space.

The problem with all of these tensioning schemes is that the coils, shock cords, and other elastic means all suffer from the same problem—they will weaken and lose their ability to maintain the flexible substrate taught and wrinkle-free over time. This means they must be monitored, adjusted and/or replaced as time goes on. The environments that these trucks see in the course of normal commercial operations will also affect the performance of these tensioning systems. Temperature variations can cause some to slacken and others to freeze. Sunlight will degrade the performance of shock cords. Dirt, grime and oil, all elements typically found in the life of commercial delivery vehicles, can interfere with the action of the winches and adjusting mechanisms.

Delivery trucks with the flexible substrates stretched over the roll up door panels also suffer from another weakness—wind coming in from the sides and putting stress on the mounting systems. This air turbulence, a natural and expected condition created when the truck moves, gets between the outer face of the roll up door and the backside of the flexible substrate to create a force pushing the substrate outward. Trucks with conventional tensioning systems have been observed with tears at the substrate attachment points and even with whole sections of the substrate torn away from the door.

In addition, decal systems are sometimes used. Decal systems, however, are not optimal solutions for today's advertisers for a number of reasons including the fact that the decals must be cut into slices that fit on the horizontal door panels and do not cover the joints between the panels. Anyone who has seen the rear roll up door of delivery truck with the decals affixed will remember the harsh horizontal lines slicing through an otherwise clean advertising display. Additionally, installing these cut up graphics so that all vertical lines, colors and other image elements align properly takes time and special expertise. These facts make for an advertising display that is rarely, if ever changed, and thus is unresponsive to the dynamic tempo of today's ad campaigns.

Thus, it would be desirable to provide a signage system operable for use on roll-up door systems that securely attaches advertising to the rear face of delivery trucks and trailers fitted in a manner that is inexpensive to install, requires little or no maintenance, and can support the rapid change out of the advertising indicia as part of a dynamic promotional campaign, as well as that accommodates both day and night (backlit) display substrates/presentations.

### SUMMARY OF THE INVENTION

A system for mounting signage onto the door area of a vehicle is disclosed. The system includes a mounting assembly and a display substrate. The mounting assembly includes a series of brackets operable to capture the display substrate against the panels of a roll-up door system. Specifically, the brackets may include an upper bracket mounted to the uppermost door panel, a lower bracket mounted to the lowermost door panel, and a plurality of side brackets each selectively mounted to one or more of the door panels. The substrate is configured to flex at predetermined points to accommodate the pivoting of adjacent door panels during the opening/closing of the door.

The mounting system can be used in all of its possible embodiments to turn any roll up door, such as those typically found on large commercial garages and freight loading bays, into an advertising platform.

### BRIEF DESCRIPTION OF THE DRAWINGS

FIG. 1 illustrates a trailer having roll-up door system.

FIG. 2 illustrates a side and top views of a side mounted bracket in accordance with an embodiment of the present invention.

FIG. 3 is a top view of a top-mounted bracket in accordance with an embodiment of the present invention.

FIG. 4 illustrates side and top vies of a side-mounted bracket coupled to a panel of the roll-up door system illustrated in FIG. 1.

FIG. 5 illustrates a bracket system including the side-mounted brackets of FIG. 2 and the top-mounted brackets of FIG. 3 attached to the roll-up door system shown in FIG. 1.

FIG. 6 illustrates a cross sectional view of the bracket system of FIG. 5, showing the side-mounted bracket capturing a display substate to a door panel of the roll-up door system.

FIG. 7 illustrates a side perspective view the attached bracket system of FIG. 5.

FIG. 7A illustrates a close-up view of the joint between two roll-up door panels of FIG. 7, showing a hinge between the adjacent panels.

FIG. 7B illustrates the joint of FIG. 7A, showing the flexing of the display substrate as adjacent door panels pivot with respect to each other.

FIG. 8 illustrates a side view a bottom bracket in accordance with an embodiment of the invention, showing the upper leg of the bracket rotating around the a hinge through an arc of approximately 180 degrees

Like reference numerals have been used to identify like elements throughout this disclosure.

### DETAILED DESCRIPTION OF THE INVENTION

FIG. 1 is an elevation view showing the rear face of a typical cargo trailer fitted with a cargo door of the type having roll-up break panels 1. The truck side view mirrors 2 define the width dimension clearance of the vehicle. The rear stop and taillights 3, and retro-reflective conspicuity tape 4 are also shown.

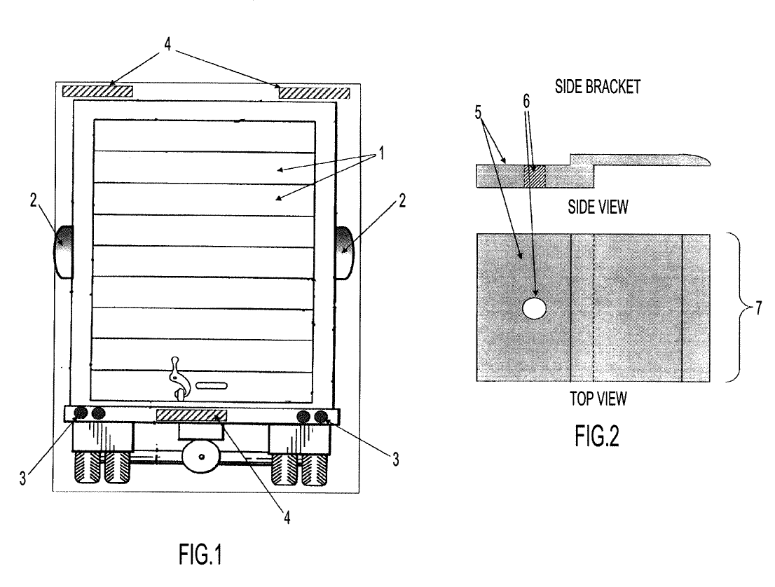

FIG. 2 presents top and side views of a typical left side bracket 5 (right side opposite hand), with the ‘leg’ of the bracket that touches the truck door panel of one possible design that can be extruded or machined from aluminum, other materials, or molded from a suitable plastic. One or more holes 6 pre-drilled or cast in this ‘leg’ of the bracket can be provided for mounting screws or other attachment means, and can be positioned in the middle of the width 7 of the bracket, said width set either to fit on 12 inch wide or 16 inch wide door panels.

FIG. 3 presents a top view of the top bracket 10 fabricated in a similar manner to the side bracket 5 presented above. The width 8 of the top bracket can span the full width of the horizontal door panel, typically a distance up to 96 inches, or the top portion of the ‘frame’ described above can be formed from one or more of 10 of shorter length installed end-to-end. The depth 9 of top bracket 10 is greater than that set for the side brackets 5 in order to maintain capture of the substrate as the roll-up door bends at the joints between the panels.

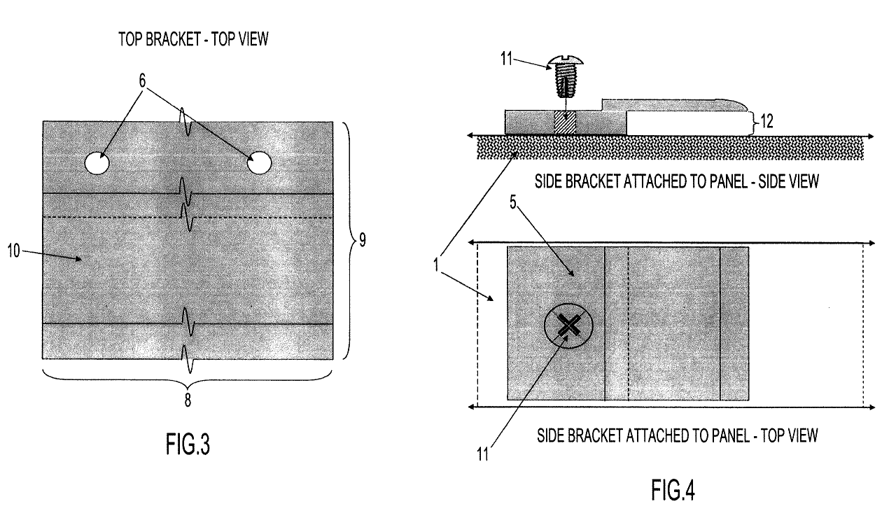

FIG. 4 presents the top and side views of the side bracket 5 attached to a typical roll-up door panel 1. A self-tapping wood screw 11 is shown as one example of the attachment means to hold the side bracket to the panel, with the screw 11 passing through the pre-drilled hole 6 in side bracket 5. The depth 12 of the “U” channel formed between the outer face of the roll-up door panel and the inside surface of the outer ‘leg’ of the bracket should be set to accommodate the thickness of the substrate chosen for the application. Those experienced in the field will recognize that alternative bracket configurations, such as one incorporating a complete “U” channel as opposed to using the outer face of the panel, are possible without varying from the essential design concept of the proposed invention.

FIG. 5 presents a complete array of brackets attached to the panels 1 of the roll-up door on the rear of a delivery truck in a pattern forming the ‘frame’ described above to capture and hold securely the substrate 16 with the advertising indicia 15 attached and facing outward. The array of brackets includes the side bracket 5 used on both sides, the top bracket 10 seen as one piece although a segmented variant is possible as discussed above, and the bottom bracket 13 running horizontally across one panel. The bottom bracket 13 can be one piece or segmented as discussed above with the top bracket 10. The bottom bracket 13 shown incorporates a hinge subassembly 14 running horizontally that when closed holds the substrate securely in the “U” channel formed with the outer surface of the panel 1, and when open allows the outer ‘leg’ of the bottom bracket 13 to fold out and down to permit rapid removal of the substrate 15 by sliding said substrate down and out of the ‘frame.’

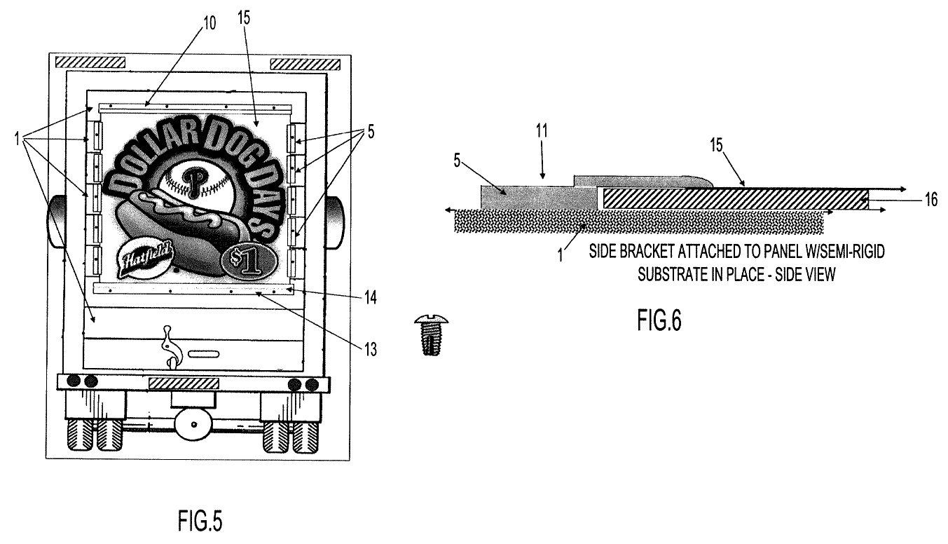

FIG. 6 presents a side view of the side bracket 5 mounted to the panel 1 and held in place by the screw 11. Those familiar with industrial design will recognize that the view presented is the passenger side looking down or the driver side looking up. The substrate 16 fits securely in the “U” channel formed by the side bracket 5 and the panel 1, with the advertising indicia 15 exposed and visible. The cutaway view of the substrate 16 is seen perpendicular to the corrugation flutes, which run parallel to the top and bottom brackets and the door panels.

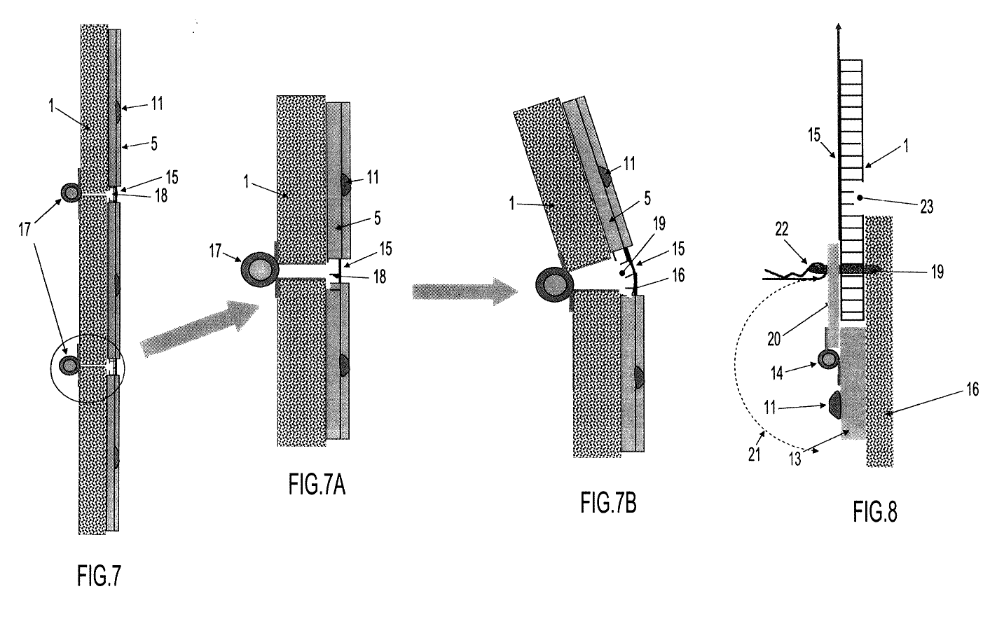

FIG. 7 presents a three-panel section of the roll-up door as seen end-on from the driver side of the vehicle showing the panel 1 with the side brackets 5 attached securely to the door using the wood screw 11 holding the substrate 16 securely in place with the advertising indicia 15 visible to audiences behind the vehicle. Hinges 17 hold the roll-up door panels 1 together and enable the door assembly to traverse the bend in the tracks fixed to the sides and roof of the truck cargo door aperture.

FIG. 7A is an exploded view of the joint between two roll-up door panels showing the hinge 17 between the two panels 1 and illustrating that the interior side of the corrugated substrate 16 has been cut away in the area directly across from the hinge. FIG. 7B is the exploded view illustrating 19 how by cutting away part of the interior side of the corrugated substrate 16, a ‘living hinge’ is created that allows the substrate to flex as the roll-up door is raised and lowered and the door panels move through the arc required to traverse the bend in the tracks noted above.

FIG. 8 presents a side view of one bottom bracket embodiment 13, when seen from the passenger side of the vehicle, illustrating how the upper ‘leg’ 20 of the bracket rotates around hinge 14 through an arc 21 of approximately 180 degrees. The bottom bracket assembly 13 is mounted horizontally along one panel 1 of the roll-up door assembly and held in place by several wood screws 11 or other attachment means. The upper ‘leg’ 20 of the bottom bracket when rotated upward is held in place by a suitable locking mechanism such as lock pins 22 connected through a pin 23 fixed into the panel 1 and feeding through a predrilled hole in the upper ‘leg’ 20 of the bottom bracket assembly. Pin 23 also fits through pre-cut holes in the substrate 16 and serves to anchor the substrate in place during the movement of the vehicle and the raising and lowering the door.

Thus, the above-described system provides a system for securely attaching advertising to the rear face of local delivery trucks and trailers fitted with roll-up cargo doors in a manner that is inexpensive to install, requires little or no maintenance, and can support the rapid change out of the advertising indicia as part of a dynamic promotional campaign is fully met by the present invention which fully supports both day and night (backlit) presentations. The present invention is an assembly that enables fleet owners and operators to display advertising indicia inexpensively on the rear face of a delivery truck fitted with roll up doors. The assembly includes an array of brackets that mount securely to the horizontal panels that form the roll up door. These brackets can be formed from metals such as aluminum or steel, structural polymers, or other suitable materials. The brackets can be attached to the individual horizontal roll up door panels (‘the panels’) by screws, nails, industrial adhesives or other appropriate fastening means.

In one embodiment, the brackets have an L-shaped configuration when viewed side-on. Other variations that will suffice would have the brackets in a form of “Z” or “S” configurations when viewed side-on. The brackets can be formed by bending sheet material to take on the desired shape or by other manufacturing processes such extrusion. Each bracket has one (or more) pre-drilled fastener hole(s) to facilitate mounting to the panel. When attached to a panel, the one ‘leg’ of the bracket with the pre-drilled fastener hole lies flat against the panel, which then results in the other ‘leg’ being set off from the surface of the panel by some predetermined stand off distance, effectively forming a “U” channel with the outer surface of the panel.

Typically, the brackets of the system come in a set of three configurations: brackets, a top bracket, and a bottom bracket assembly. Brackets used on the two vertical sides may be identical and of a length approximately equal to the width of each panel (typically 12 inches or 16 inches). By simply rotating a side bracket 180 degrees, side brackets can be installed so that the “U” channels formed with the outer surface of the panels face each other. Note that because the side brackets are of a length that corresponds to the width of the horizontal panels that make up the roll up door, no side bracket overlaps the joints that hold a specific panel to the panels above and below it so as to restrict the doors articulation. The top bracket will affix to a single panel with the resulting “U” channel facing down. As logically follows, the bottom bracket assembly is affixed to a single panel with the resulting “U” channel facing up.

It will be appreciated that by affixing an array of brackets end to end in a square or rectangular box pattern, the brackets form a continuous “U” channel along the inner four sides of the pattern. It will also be recognized that the continuous “U” channel so formed creates a border frame that can be used to hold a rigid or sufficiently semi-rigid substrate securely at the outer face of the roll up door.

The display substrate may be rigid or semi-rigid, and is configured to flex along preset horizontal areas that correspond to the joints between the door's panels. Without this flexibility, the substrate will prevent the roll up door panels from traversing the bend radius of the left and right tracks that hold the door in place and guide it into its housing in the roof of the vehicle when it is lifted open. The bend radius varies with the door installed, but is typically between 10 and 12 inches. A variety of materials may serve as the substrate, including a number of plastics that can be formed into thin sheets such as polycarbonate and PVC. Rigid materials such as wood and metal can also be used if the substrate is formed from slats of the material having approximately similar widths as the doors panels. The slats would then be held together along their upper and lower edges using a flexible tape or other means so that the slat-formed substrate will bend with the door.

The preferred embodiment uses a corrugated plastic such as Coroplast or Duratherm as the substrate. Sheets of this material are commercially available in widths to 96 inches and lengths to 12 feet, more than sufficient to cover the cargo doors on most delivery trucks. These materials are widely used as the backing for advertising graphics and signage, and can be printed on directly. They are durable, weather resistant, and lightweight to the point that even the largest sheets are one man portable. Corroplast is available in thicknesses of 4 mm to over 10 mm. A feature of the invention is that the corrugated plastic sheets are fabricated in such a way that by slitting the outer wall on one side and leaving the other side of the corrugation intact, the remaining wall becomes a ‘living hinge’ capable of an almost unlimited number of flexes. By slitting the wall of the corrugated sheet facing the door panels, the outer wall can flex allowing the substrate to bend along any radius the panels must traverse. The substrate will restore with no crazing or creasing when the door is pulled down and closed.

Thus, the display substrate may be generally rigid, but may include a series of living hinges generally aligned with the pivot areas of adjacent door panels in the roll-up door system. The living hinges permit the selective bending/flexing of substrate sections as the door opens/closes.

The invention comprises the brackets—sides, top and bottom—and the substrate with the advertising indicia adhered to or printed on the outer surface and the slits cut on the inner surface facing the door panels. Once the brackets are attached to the panels, the substrate can slide into the “U” channel frame formed with the outer surface of the door. Given that the slits properly match up with the joints between the panels, the entire assembly will stay securely in place when the door is closed and will traverse the bend when the roll up door is opened and closed.

An additional and important feature of the proposed invention is the ability to ensure that the substrate stays properly positioned within the ‘frame’ during repeated openings and closings of the door. Since the substrate bends but does not stretch, if it is not anchored properly, there is the possibility that the substrate will pull out from the top or bottom “U” channel as the door is rolled up or down. To prevent this, one embodiment of the invention has the lower bracket fitted with pins that go through holes drilled in the bottom edge of the substrate to hold the substrate firmly in the lower “U” channel. Since the substrate cannot now move or stretch, unless otherwise restrained, its top edge will slide out of the “U” channel a distance equal to the difference of the arc of the actual door as it slides up (and down) in the tracks and the arc of the substrate attached to its outer face. To prevent this from happening, the ‘leg’ of the upper bracket forming the “U” channel extends this additional length plus a satisfactory safety margin. The resulting deeper “U” channel along the top edge of the ‘frame’ holds the substrate properly in place as the roll up door articulates.

The assembly described above, including the brackets (top, bottom and sides) attached to the roll up door panels in the desired pattern, and the substrate appropriately dimensioned to fit securely in the resulting “U” channel frame, will provide a seamless surface for an advertising display on the rear of the delivery truck. To provide the ability to rapidly swap out one advertising display for another as part of a multi-channel, time sensitive promotional campaign, the bottom bracket illustrated in FIG. 8 may be utilized. A preferred embodiment of the proposed invention includes a bottom bracket assembly that opens to allow the substrate to be pulled free of the ‘frame.’ The left and right “U” channels have sufficient slack to allow the substrate to slide in and out of the ‘frame’ with minimal time and effort and no special tools. The ease with which the substrate can be pulled out of the ‘frame’ and a new one slid in place enables changing the advertising message at will in minutes. This is entirely responsive to the operational constraints of a commercial delivery operation, enabling the advertising indicia to be swapped out while the truck is being reloaded or refueled by personnel on hand with no special tools or training.

The bottom bracket assembly can incorporate a hinge that allows the leg that forms the “U” channel with the rear door panel to release and fold down 180 degrees to allow the release of the substrate carrying the advertising indicia. When the new substrate is inserted and positioned into the ‘frame’ with the anchor pins in the bracket holding the substrate in place, the bracket ‘leg’ can be rotated back into place and locked to complete the ‘frame’ around the substrate.

Those experienced in the field will recognize that other means for releasing the substrate from the ‘frame’ are possible, such a hinging all of the brackets along one side so that the substrate can be removed and reinserted laterally from one side or the other as opposed to from the bottom. The description above is not meant to be limiting. What is intended is that the truck driver/operator be able to insert and remove the substrate rapidly with no special tools or training required.

An additional advantage of the proposed invention is the fact that the candidate substrates can securely support the use of electro-luminescent (EL) panels for backlighting purposes. Examples of EL panels are those manufactured by E-Lite Technologies, Inc., of Trumbull, Conn. and sold under the trademark FLATLITE. There are other sources of EL panels that will work equally as well for the purposes of the present invention. These EL panels are capable of bending with the substrate as the roll up door is opened and closed as long as the bend radius is held within acceptable limits. These panels should not be creased, which is a realistic concern with tensioning systems that can come loose.

The current state of EL panel technology is such that these thin, visible light sources can be bonded or otherwise attached to the substrate itself before the actual advertising indicia is applied. Various masking techniques can be used between the EL panel and the advertising indicia are part of the backlighting strategy. Having the substrate between the EL panel, which is expensive and somewhat fragile, and the panels of the roll up door protects the EL panel and any electrical circuitry from being pinched or otherwise damaged by the normal operation of the door.

The top bracket can also incorporate a strain relief to protect the electrical connection needed to feed power to the EL panel. Alternatively, the top bracket could have a power interface where the power lead from the EL panel is plugged in to a receptacle on one side of the interface and a power lead connected to the vehicle power supply plugs into the other side. The brackets and the substrate described in the proposed invention should be installed so that they do not cover, obscure, block viewing of or otherwise detract from the tail lights, back up lights, conspicuity tapes and hazardous cargo markings or other safety devices fitted to the delivery truck or cargo trailer.

While the present invention has been described in detail and with reference to specific embodiments thereof, it will be apparent to one skilled in the art that various changes and modifications can be made therein without departing from the spirit and scope thereof. Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

We claim:

1. An assembly for mounting an advertising display or other visual presentation on roll-up door systems, the assembly comprising:
an array of brackets that are shaped so that when individually mounted to the panels of the roll up door and aligned properly, they collectively form a frame that can hold a rigid or semi-rigid substrate securely to the outer face of the door panels, wherein the top bracket formed so as to provide an extended channel for holding the substrate securely even as the roll-up door panels traverse the arc necessary for the door to open and close, and with said rigid or semi-rigid substrate made from a corrugated material so that the inner skin of the substrate can be cut or scored along the corrugations to allow the outer skin of the substrate to act as a living hinge and the substrate to bend appropriately as the door is raised and lowered.

2. The assembly in claim 1 wherein the brackets of the frame are formed from a plastic.

3. The assembly of claim 1 wherein the bottom bracket opens to allow the substrate with the advertising indicia to be inserted and removed from the ‘frame.’

4. The assembly of claim 1 wherein any side, top or bottom of the frame can be opened to allow the substrate with the advertising indicia to be inserted and removed from the frame.

5. The assembly of claim 1 wherein the substrate is a corrugated plastic.

6. The assembly of claim 1 wherein the advertising indicia is printed on the outer surface of the substrate.

7. The assembly of claim 1 wherein the advertising indicia is applied as a decal to the outer surface of the substrate using an adhesive.

8. The assembly of claim 7 wherein an electro luminescent (EL) panel, or an array of EL panels, is attached to the outer surface of the substrate to serve as a backlight source for the advertising indicia which is attached as a decal over the substrate and EL panel(s).

9. The assembly of claim 7 wherein the brackets of the frame are formed from a plastic.

10. The assembly of claim 7 wherein the bottom bracket opens to allow the substrate with the advertising indicia to be inserted and removed from the frame.

11. The assembly of claim 7 wherein any side, top or bottom of the frame can be opened to allow the substrate with the advertising indicia to be inserted and removed from the frame.

12. The assembly of claim 7 wherein the substrate is a corrugated plastic.

13. The assembly of claim 1 wherein the substrate is a uniform sheet of material capable of flexing around the bend created by the movement of the roll up door panels as the door is raised and lowered without creasing.

14. The assembly of claim 7 wherein the substrate is a uniform sheet of material capable of flexing around the bend created by the movement of the roll up door panels as the door is raised and lowered without creasing.

15. The assembly of claim 13 wherein the substrate is a plastic.

16. The assembly of claim 14 wherein the substrate is a plastic.
